(19) United States
(12) Patent Application Publication
(10) Pub. No.: US 2021/0080760 A1
(43) Pub. Date: Mar. 18, 2021

(54) SYSTEM AND METHOD FOR REDUCING BEAM DISTORTION

(71) Applicant: Pony Al Inc., Grand Cayman (KY)

(72) Inventors: Peter G. Diehl, Shanghai (CN); Robert Dingli, Cupertino, CA (US)

(21) Appl. No.: 16/569,455

(22) Filed: Sep. 12, 2019

(51) Int. Cl. G02F 1/01; G02F 1/19

(52) U.S. Cl. CPC G02F 1/0147; G01S 7/497; G02F 1/19

(57) ABSTRACT

Provided herein is a system and method for correcting an imperfection of a medium through which beams pass to a sensor. The system comprises a controller that determines an amount of heat to be applied to the medium and a location at which the heat is to be applied. The system comprises a heating element that applies the determined amount of heat to expand the medium at the determined location, to reduce a refractive effect of the beams passing through the medium, and to allow the beams passing through the medium to converge to a single focal point.

### FIELD OF DISCLOSURE

The present disclosure relates generally to vehicles equipped with sensors such as optical sensors that capture images and/or data through a medium such as glass or plastic, and adjusting for distortions in the images and/or data resulting from transmission of beams through the medium. In particular, some embodiments relate to correction of images and/or data of an sensor placed in front of a medium.

### BACKGROUND

When a sensor such as a camera, LiDAR sensor, or infrared sensor is placed in front of a medium such as glass or plastic, imperfections or curvature of the medium may cause distortion of beams transmitted to the sensor, resulting in distortions or inaccuracies of images or data captured by the sensor. Imperfections of the medium may be caused, for example, by changes in temperature, changes in barometric pressure, changes in elevation, wind, glazing pressure around a periphery for glass, and a heat treatment process used, for instance, in heat-strengthened or tempered glass. For instance, tempered glass is made by heating and rapidly cooling the glass during quenching, in which outer surfaces are cooled more quickly than center portions. The quenching process places the outer surfaces in compression and the center portions in tension. When an imperfection occurs in a medium, a beam transmitted to a sensor may be refracted at an angle less than the incident angle, which would cause a distortion or inaccuracy of the image or data captured by the sensor. Inaccuracies of sensor data captured by a vehicle may compromise safety of the vehicle. These shortfalls are addressed by the present disclosure, which provides a system and method to reduce or eliminate distortion or imperfections of a medium to capture accurate images or data by sensors after beams pass through the medium and to ensure reliable and safe functioning of a vehicle.

### SUMMARY

Described herein are systems and methods for correcting an imperfection in a medium through which beams of an sensor pass through. Various embodiments of the present disclosure provide a correction system to correct an imperfection of a medium through which beams pass to a sensor, comprising a controller configured to determine an amount of heat to be applied to the medium and a location at which the heat is to be applied and a heating element configured to apply the determined amount of heat to the medium at the determined location. The heating element reduces a refractive effect of the beams passing through the medium, and allows the beams passing through the medium to converge to a single focal point.

In some embodiments, the medium is positioned in front of an sensor to which the beams are transmitted. The controller is configured to determine the amount of heat based on a comparison between data captured by the sensor and reference data, determine the location at which the heat is to be applied to be a location within a field of view of the sensor, and move the heating element to the determined location.

In some embodiments, the controller is configured to determine the amount of heat to be such that, in response to the amount of heat being applied to the medium, a difference between a parameter of the data captured by the sensor and a parameter of the reference data is less than a threshold.

In some embodiments, the controller is configured to determine a duration, frequency, or pattern of the heat to be applied to the medium based on a comparison between data captured by the sensor and reference data; and in response to the determination, the heating element is configured to apply the determined duration, frequency, or pattern of the heat to the medium.

In some embodiments, the correction system further comprises a second heating element. In some embodiments, the controller is further configured to determine a second amount of heat to be applied by the second heating element.

In some embodiments, the second amount of heat is less than the amount of heat.

In some embodiments, the medium comprises a layered composition including a layer of plastic between two outer layers of a glass, and the heating element is disposed on an exterior of and adjacent to one of the outer layers of the glass. In some embodiments, the second heating element is disposed on an exterior of and adjacent to an other of the one of the outer layers of the glass.

In some embodiments, the controller is further configured to determine an amount of pressure to be applied to the medium at the determined location; and further comprising: a pressure actuator configured to apply the determined amount of pressure.

In some embodiments, the controller is further configured to determine the amount of pressure and the amount of heat to be such that, in response to the amount of heat and the amount of pressure being applied to the medium, a difference between a parameter of the data captured by the sensor and a parameter of the reference data is less than a threshold.

In some embodiments, the controller is further configured to limit the amount of pressure or the amount of heat based on a fracture toughness of the medium.

In some embodiments, in response to the controller determining the pattern of the heat, the pattern of the heat comprises a first pulse of heat at a first amplitude for a first duration and a second pulse of heat at a second amplitude for a second duration, wherein the second amplitude is lower than the first amplitude.

Various embodiments of the present disclosure provide a correction method to correct an imperfection of a medium, comprising: determining, by a controller, an amount of heat to be applied to the medium and a location at which the heat is to be applied; and applying, by a heating element, the determined amount of heat to the medium at the determined location. The applying the determined amount of heat reduces a refractive effect of the beams passing through the medium, and allows the beams passing through the medium to converge to a single focal point.

In some embodiments, the determining the amount of heat is based on a comparison between data captured by a sensor and reference data, the medium being positioned in front of the sensor; and further comprising: determining a field of view of the sensor; determining the location at which the heat is to be applied to be a location within the determined field of view; and moving, by the controller, the heating element to the determined location.

In some embodiments, the determining the amount of heat comprises determining the amount of heat to be such that, in response to the amount of heat being applied to the medium, a difference between a parameter of the data captured by the optical sensor and a parameter of the reference data is less than a threshold.

In some embodiments, the method further comprises: determining a duration, frequency, or pattern of the heat to be applied to the medium based on a comparison between data captured by the sensor and reference data; and in response to the determining the duration, frequency or pattern, applying the determined duration, frequency, or pattern of the heat to the medium.

In some embodiments, the method further comprises: determining, by the controller, a second amount of heat to be applied by a second heating element.

In some embodiments, the determining the second amount of heat comprises determining the second amount of heat to be less than the amount of heat.

In some embodiments, the method further comprises: determining an amount of pressure to be applied to the medium at the determined location; and applying the determined amount of pressure at the location.

In some embodiments, the determining the amount of pressure and the amount of heat comprises determining the amount of pressure and the amount of heat to be such that, in response to the amount of heat and the amount of pressure being applied to the medium, a difference between a parameter of the data captured by the sensor and a parameter of the reference data is less than a threshold.

In some embodiments, the determining the amount of pressure comprises determining the pattern of the heat to comprise a first pulse of heat at a first amplitude for a first duration and a second pulse of heat at a second amplitude for a second duration, wherein the second amplitude is lower than the first amplitude.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIGS. 1A-1B illustrate examples of distortions of sensor data resulting from a medium disposed in front of a sensor.

FIG. 1C illustrates a schematic diagram of an exemplary correction mechanism as performed by a correction system.

FIG. 2A illustrates an example of a correction mechanism to correct a medium disposed in front of a sensor.

FIG. 2B illustrates an example of a determination mechanism to determine an amount of heat to correct the medium, corresponding to FIGS. 2A, 3A, 4A, 5, 6, and 7.

FIG. 3A illustrates an example of a correction mechanism to correct a medium disposed in front of a sensor.

FIG. 3B illustrates patterns of heat applied to the medium in accordance with FIG. 3A.

FIG. 4A illustrates an example of a correction mechanism to correct a medium disposed in front of a sensor.

FIG. 4B illustrates patterns of heat and pressure applied to the medium in accordance with FIG. 4A.

FIGS. 5-7 illustrate configurations of a correction system to correct a medium disposed in front of a sensor.

FIG. 8 illustrates a flowchart of a method to correct an imperfection of a medium.

FIG. 9 is a block diagram that illustrates a computer system 900 upon which any of the embodiments described herein may be implemented.

### DETAILED DESCRIPTION

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

In general, a vehicle (e.g., an autonomous vehicle, a driverless vehicle, etc.) can have myriad sensors onboard the vehicle. The myriad sensors can include light detection and ranging sensors (or LiDARs), radars, cameras, GPS, sonar, ultrasonic, IMU (inertial measurement unit), accelerometers, gyroscopes, magnetometers, FIR (far infrared) sensors, etc. The myriad sensors can play a central role in functioning of an autonomous or driverless vehicle. For example, LiDARs can be utilized to detect and identify objects (e.g., other vehicles, road signs, pedestrians, buildings, etc.) in a surrounding. LiDARs can also be utilized to determine relative distances of the objects in the surrounding. For another example, radars can be utilized to aid with collision avoidance, adaptive cruise control, blind side detection, assisted parking, etc. For yet another example, camera can be utilized to recognize, interpret, and/or analyze contents or visual cues of the objects. Cameras and other sensors can capture image data using charge coupled devices (CCDs), complementary metal oxide semiconductors (CMOS), or similar elements. An IMU may detect abnormal occurrences such as a bump or pothole in a road. Data collected from these sensors can then be processed and used, as inputs, to make driving decisions (e.g., acceleration, deceleration, direction change, etc.). For example, data from these sensors may be further processed into an image histogram of a graphical representation of tonal distribution in an image captured by the one or more sensors.

Data from a sensor may be rendered inaccurate when a sensor is positioned in front of a medium such as glass or plastic. Imperfections or curvature of the medium may cause distortions of beams transmitted to or reflected or refracted back to the sensor, resulting in inaccuracies of the data. Correcting or adjusting such imperfections or curvature of the medium, for example, by applying heat, may reduce or eliminate such inaccuracies of the data.

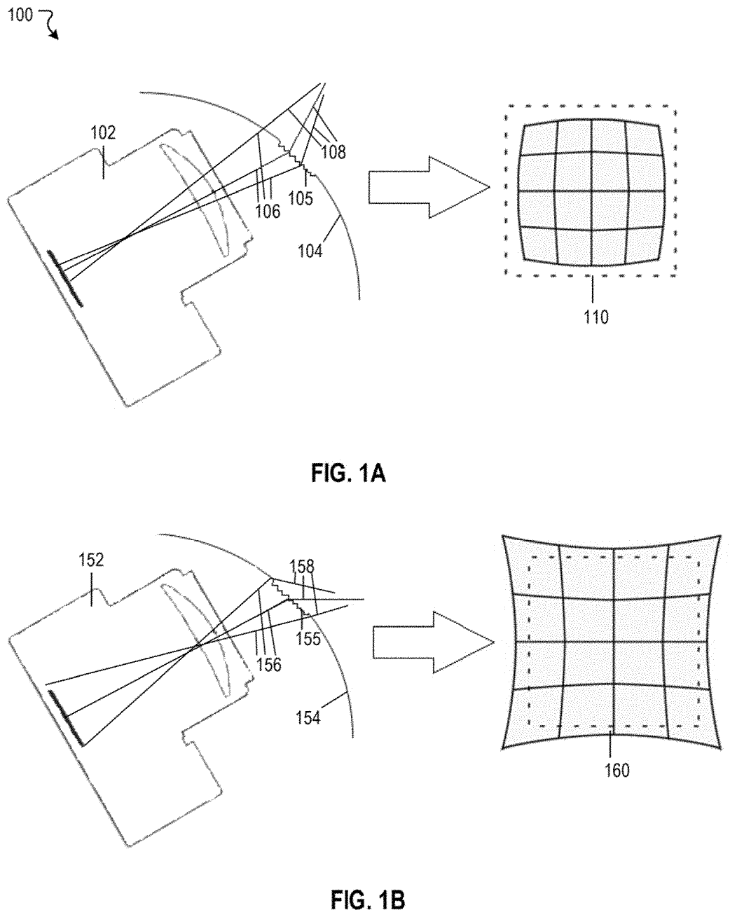

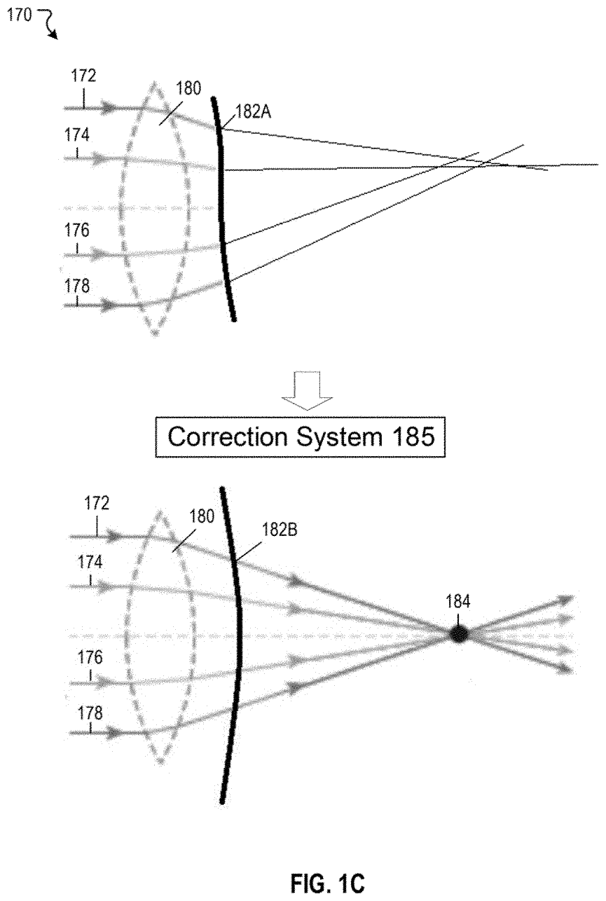

FIG. 1A illustrates an example 100 of a distortion of sensor data resulting from a medium disposed in front of a sensor. In FIG. 1A, a sensor 102, such as a camera or LiDAR sensor, may receive beams 106. Beams 108 may pass through an imperfection 105 of medium 104. The medium 104 may comprise glass or plastic. The beams 108, after being transmitted through the imperfection 105, may be refracted as the beams 106 due to the imperfection 105. A resulting image may comprise a barrel distortion 110.

FIG. 1B illustrates an example 150 of a distortion of sensor data resulting from a medium disposed in front of a sensor. In FIG. 1B, a sensor 152, such as a camera or LiDAR sensor, may receive beams 156. The beams 158 may pass through an imperfection 155 of medium 154. The medium 154 may comprise glass or plastic. The beams 158, after being transmitted through the imperfection 155, may be refracted as the beams 156 due to the imperfection 155. A resulting image may comprise a pincushion distortion 160.

FIG. 1C illustrates a schematic diagram of an exemplary correction mechanism as performed by a correction system 185. Initially, beams or rays 172, 174, 176, and 178 may pass through lens 180 and subsequently through medium 182A, who may comprise glass or plastic such as PMMA. The medium 182 includes imperfections that result in further unwanted refraction of the beams or rays 172, 174, 176, and 178. As a result, the beams or rays 172, 174, 176, and 178 fail to converge at a focal point. After correction system 185 applies heat to the medium 182A, which expands the medium 182A, for example, by increasing an atomic spacing of the medium 182A, and eliminates or reduces imperfections of the medium 182A. The medium 182A, following the application of heat, becomes medium 182B. A direction of the beams or rays 172, 174, 176, and 178 through the medium 182B is changed, as the unwanted refraction of the beams or rays 172, 174, 176, and 178 may be eliminated so that the beams or rays 172, 174, 176, and 178 converge into a single focal point, without converging into other focal points.

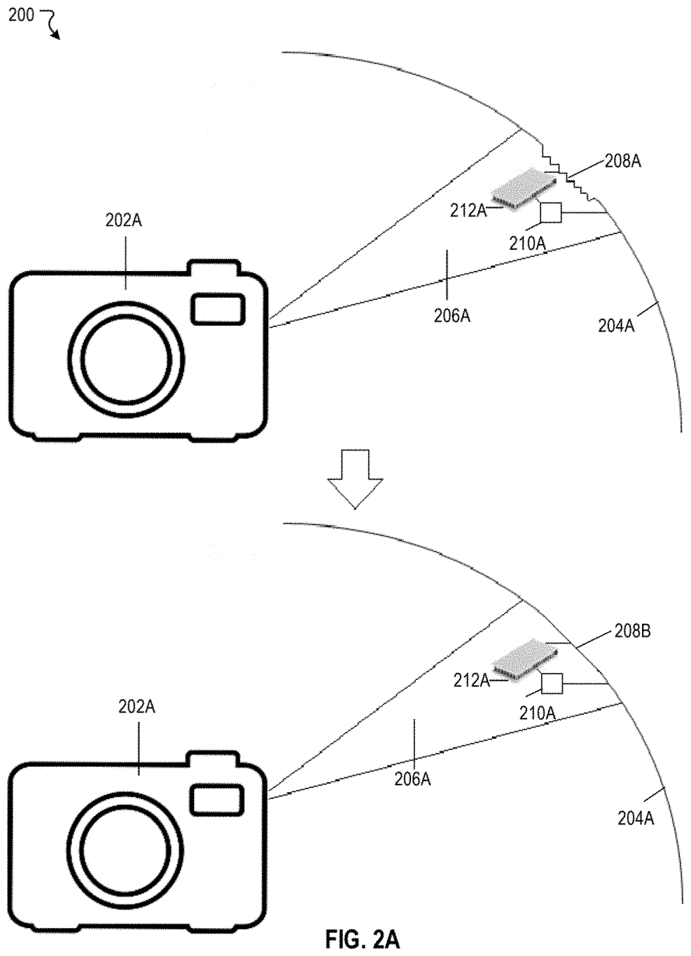

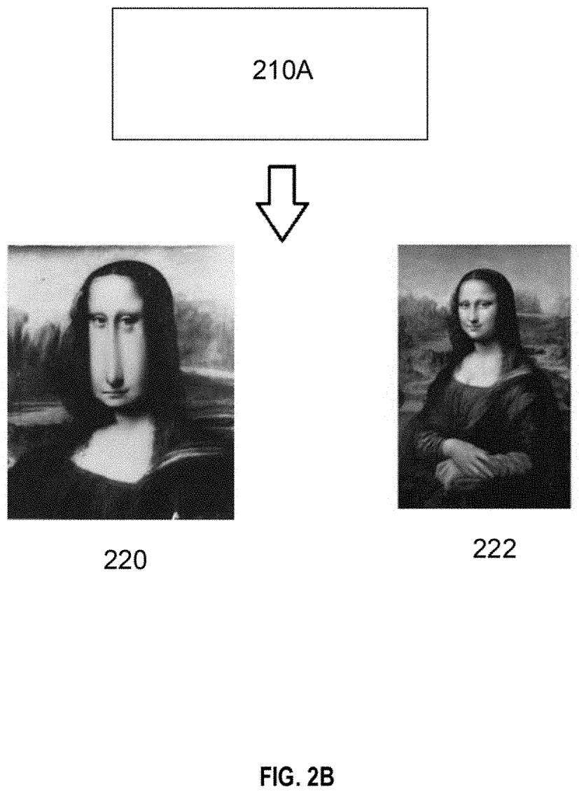

FIG. 2A illustrates an example 200 of a correction mechanism to correct a medium disposed in front of a sensor. In FIG. 2A, a sensor 202A may receive beams transmitted through a field of view 206A. The sensor 202A may be a camera, LiDAR, other optical sensor, radar, ultrasonic, infrared sensor, or other sensor. The transmitted beams may pass through a medium 204A comprising an imperfection 208A. The medium 204A may comprise a glass such as a laminated glass or a tempered glass, and/or a plastic. The imperfection 208A may comprise a nonuniform thickness of the medium 204A. A correction system to correct the imperfection 208A may comprise a controller 210A and a heating element 212A. The heating element 212A may comprise a Peltier element, a metal heating element (for example, nickel-based such as nickel-chromium or iron-based), a PTC heating element, and/or a composite heating element.

The controller 210A may determine an amount of heat to be applied to the medium 204A and a location at which the heat is to be applied. In some embodiments, the controller 210A may determine the location at which the heat is applied to be within the field of view 206A of the sensor 202A, such as a center of the field of view 206A. In some embodiments, the controller 210A may move the heating element 212A to the determined location. In some embodiments, the controller 210A may be configured to determine the amount of heat as the amount of heat required to produce an image or data satisfying a specific image quality or clarity, or a specific range of image parameters. The controller 210A may pre-determine the amount of heat on a test or pilot sample, as shown in FIG. 2B. In some examples, the controller 210A may compare actual data (e.g., 220) captured by the sensor 202A with reference data 222, which represents a desired image quality. For example, the controller 210A may determine the amount of heat required as that required to obtain an image sufficiently similar to the reference data 222, within a threshold range. As another example, the controller 210A may determine the amount of heat required as that required to obtain one or more parameters within a threshold of the parameters of the reference data 222. For example, the one or more parameters may comprise an optical center, a focal length, a skew, a distortion, an image center, a depth of field, an angle of view, a beam angle, an aspect ratio, and a pixel number, a level of noise, and the like. The one or more parameters of the reference data may be based on a time of day, an amount of ambient light, or an environment condition. In some examples, the controller 210A may dynamically determine the amount of heat during capturing of the sensor data from the sensor 202A, by dynamically assessing a quality of the sensor data or one or more parameters of the sensor data.

The controller 210A may further determine a duration, frequency, or pattern of the heat to be applied to the medium 204A. For example, the controller 210A may determine that the pattern of the applied heat to comprise a single pulse or multiple pulses of heat. For example, the controller 210A may determine the pattern of the applied heat to comprise one-second pulses of heat at constant amplitude (e.g., amount or intensity) followed by one-second breaks, a pulse of heat followed by one or more shorter pulses of heat, or a pulse of heat followed by one or more pulses of lower amplitudes (e.g., amounts or intensities) of heat. The one or more pulses of lower amplitudes, for example, may comprise pulses of constant amplitude or successively decreasing amplitudes, for instance, 1 W/m², 0.9 W/m². 0.81 W/m², wherein each successive pulse is 90% of the intensity of the previous pulse. As an example, once an amount of heat is applied to the medium 204A such that the data or the parameter from the sensor 202A is determined to be within a threshold range of the reference data 222, the controller 202A may regulate the heating element 212A to apply shorter pulses and/or amplitudes (e.g., amounts or intensities) of heat to save energy while preventing the imperfection 208A from reforming.

In response to the determination by the controller 210A of an amount of heat to be applied and the location of the heat application, the heating element 212A may apply the heat to the medium 204A. In some embodiments, the heating element 212A may directly contact the medium 204A during the application of heat. After the heating element 212A applies the heat to the medium 204A, the imperfection 208A may be reduced or eliminated, as shown in 208B.

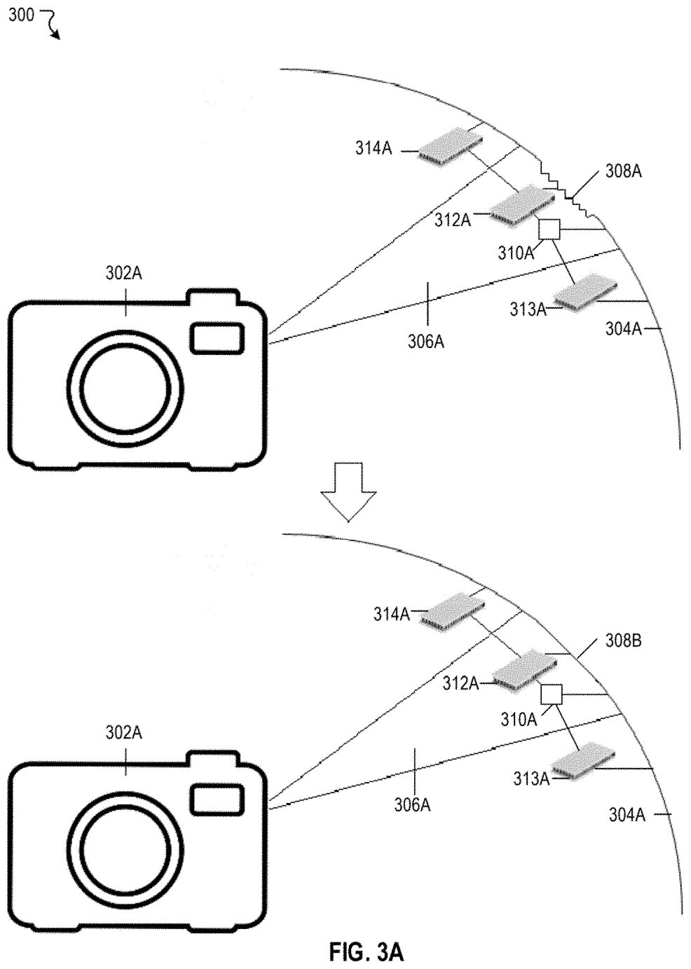

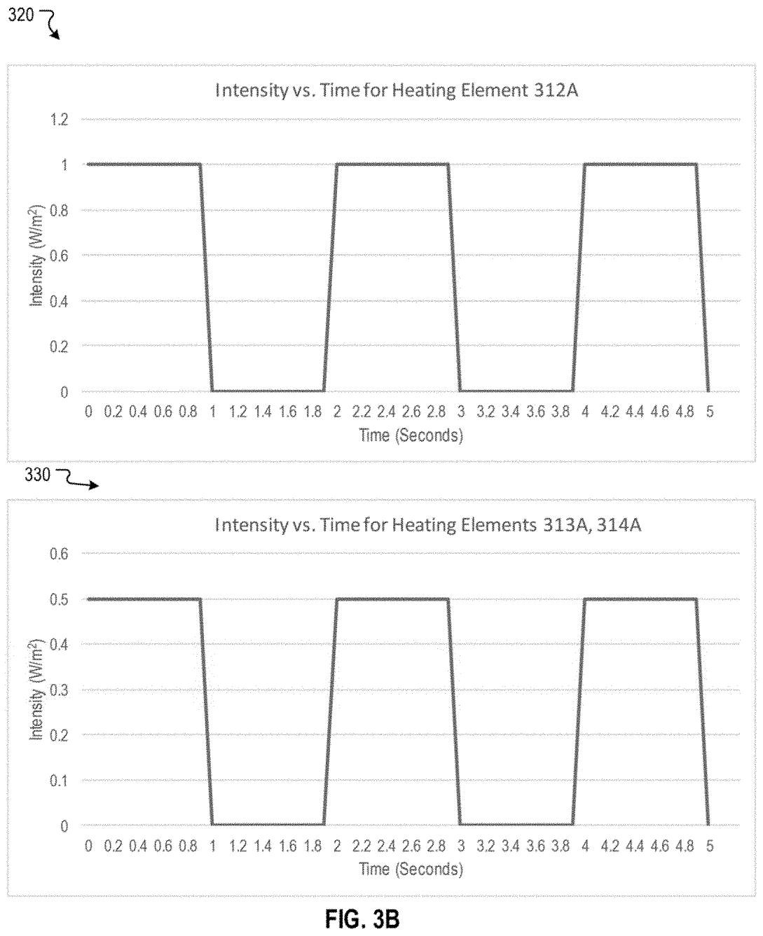

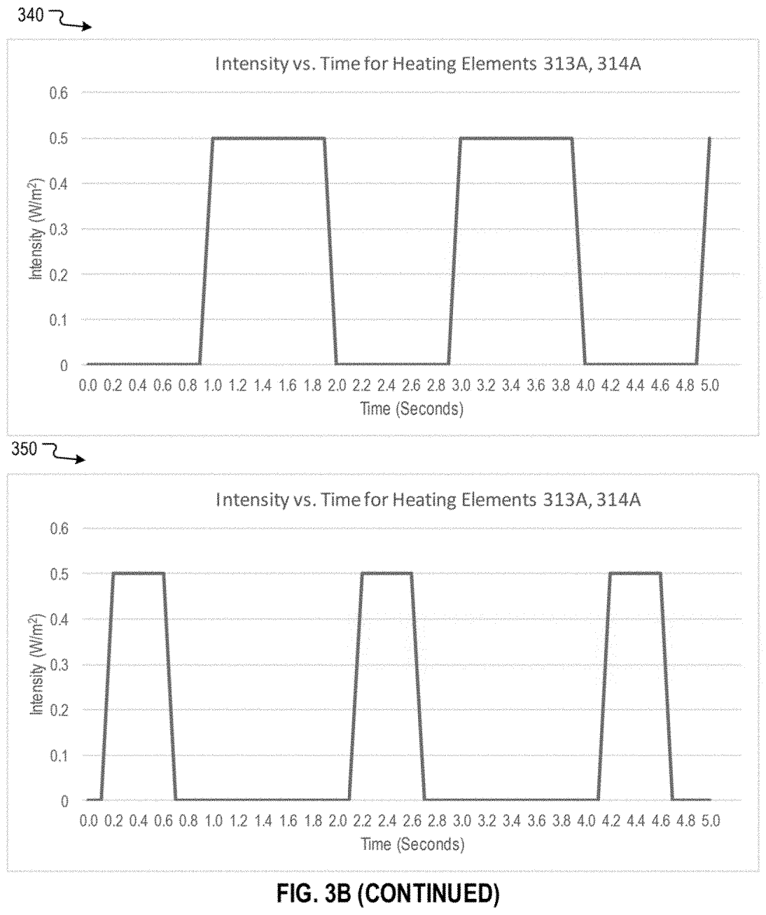

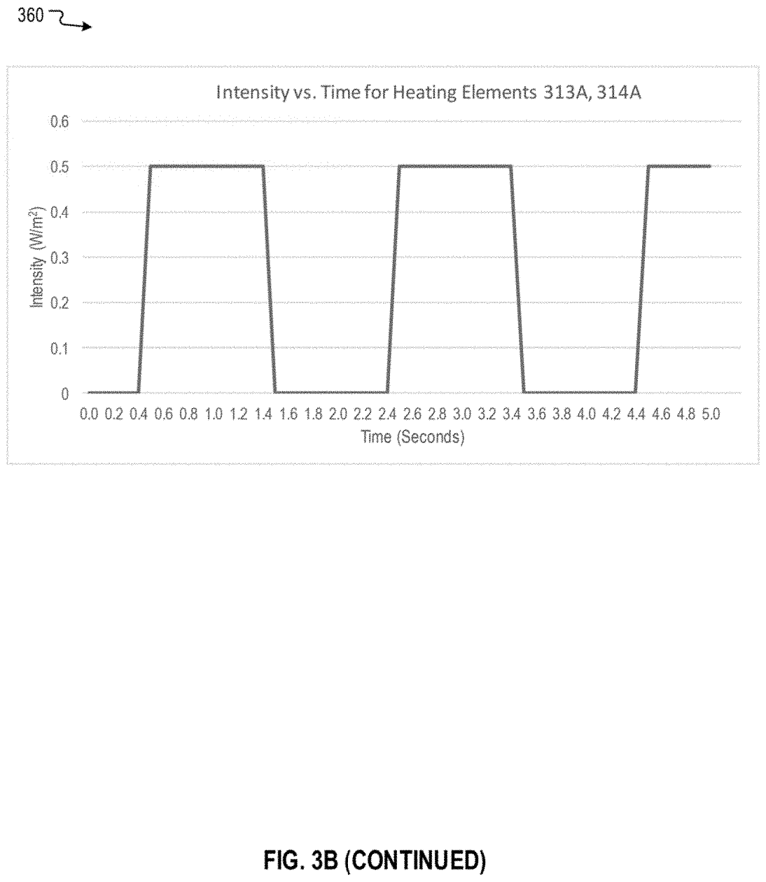

FIG. 3A illustrates an example 300 of a correction mechanism to correct a medium disposed in front of a sensor. In FIG. 3A, a sensor 302A may receive beams through a field of view 306A. The sensor 302A may be a camera, LiDAR, other optical sensor, radar, ultrasonic, infrared sensor, or other sensor. The transmitted beams may pass through a medium 304A comprising an imperfection 308A. The medium 304A may comprise a glass such as a laminated glass or a tempered glass, and/or a plastic. The imperfection 308A may comprise a nonuniform thickness of the medium 304A. A correction system to correct the imperfection 308A may comprise a controller 310A, a heating element 312A, and additional heating elements 313A and 314A. The heating element 312A and additional heating elements 313A and 314A may comprise a Peltier element, a metal heating element (for example, nickel-based such as nickel-chromium or iron-based), a PTC heating element, and/or a composite heating element. The additional heating elements 313A and 314A may be disposed within or outside the field of view 306A. The additional heating elements 313A and 314A may be disposed symmetrically around the heating element 312A. Although only two additional heating elements 313A and 314A are shown, more than two additional heating elements may be present. The additional heating elements 313A and 314A may each apply less heat compared to the heating element 312A, and may reduce a difference in strain or stress of neighboring regions caused by heat application from the heating element 312A. For example, with the additional heating elements 313A and 314A, a difference in temperature between neighboring regions of the medium 304A around the field of view 306A may be reduced, thus reducing a risk of damage due to strain or stress of the medium 304A.

The controller 310A may determine an amount of heat to be applied to different regions of the medium 304A and locations at which the heat is to be applied. In some embodiments, the controller 310A may determine one of the locations at which the heat is applied to be within the field of view 306A of the sensor 302A, such as a center of the field of view 306A. In some embodiments, the controller 310A may move the heating element 312A to the determined location. In some embodiments, the controller 310A may be configured to determine the amount of heat to be applied by the heating element 312A as the amount of heat required to produce an image or data satisfying a specific image quality or clarity, or a specific range of image parameters. The controller 310A may pre-determine the amount of heat on a test or pilot sample, as shown in FIG. 2B. In some examples, the controller 310A may compare actual data (e.g., 220) captured by the sensor 302A with reference data (e.g., 222), which represents a desired image quality. For example, the controller 310A may determine the amount of heat required as that required to obtain an image sufficiently similar to the reference data 222, within a threshold range. As another example, the controller 310A may determine the amount of heat required as that required to obtain one or more parameters within a threshold of the parameters of the reference data 222. For example, the one or more parameters may comprise an optical center, a focal length, a skew, a distortion, an image center, a depth of field, an angle of view, a beam angle, an aspect ratio, and a pixel number, a level of noise, and the like. The one or more parameters of the reference data may be based on a time of day, an amount of ambient light, or an environment condition. In some examples, the controller 310A may dynamically determine the amount of heat during capturing of the sensor data from the sensor 302A, by dynamically assessing a quality of the sensor data or one or more parameters of the sensor data.

The controller 310A may further determine a duration, frequency, or pattern of the heat to be applied to the medium 304A by the heating element 312A. For example, the controller 310A may determine that the pattern of the applied heat to comprise a single pulse or multiple pulses of heat. For example, the controller 310A may determine the pattern of the applied heat by the heating element 312A to comprise one-second pulses of heat at constant amplitude (e.g., amount or intensity) followed by one-second breaks, as shown, for example, in pattern 320 of FIG. 3B. In some examples, the pattern of the applied heat by the heating element 312A may comprise a pulse of heat followed by one or more shorter pulses of heat, or a pulse of heat followed by one or more pulses of lower amplitudes (e.g., amounts or intensities) of heat. The one or more pulses of lower amplitudes, for example, may comprise pulses of constant amplitude or successively decreasing amplitudes, for instance, 1 W/m², 0.9 W/m². 0.81 W/m², wherein each successive pulse is 90% of the intensity of the previous pulse. As an example, once an amount of heat is applied to the medium 304A such that the data or the parameter from the sensor 302A is determined to be within a threshold range of the reference data 222, the controller 302A may regulate the heating element 312A to apply shorter pulses and/or amplitudes (e.g., amounts or intensities) of heat to save energy while preventing the imperfection 308A from reforming.

The controller 310A may further determine the amount of heat to be applied by the additional heating elements 313A and 314A. In some embodiments, the controller 310A may determine the amount of heat to be applied by the additional heating elements 313A and 314A as a percentage (less than 100%) of the amount of heat applied by the heating element 312A, such as 25%, 50%, or 75%.

The controller 310A may further determine a duration, frequency, or pattern of the heat to be applied to the medium 304A by the additional heating elements 313A and 314A. For example, the controller 310A may determine that the duration, frequency, or pattern of the heat applied by the additional heating elements 313A and 314A is the same as that applied by the heating element 312A, but proportionally reduced in amplitude with respect to the heat applied by the heating element 312A, as shown in pattern 330 of FIG. 3B. For example, each pulse applied by the additional heating elements 313A and 314A may have an amplitude of 25%, 50%, or 75% as that of the heating element 312A. In some examples, the controller 310A may synchronize a pattern of the heat applied by the additional heating elements 313A and 314A to the pattern of heat applied by the heating element 312A, but may not exactly match the pattern applied by the heating element 312A. For example, the controller 310A may control the additional heating elements 313A and 314A to apply pulses of heat during breaks in which the heating element 312A does not apply pulses of heat, as shown in pattern 340 of FIG. 3B. As another example, the controller 310A may control the additional heating elements 313A and 314A to apply pulses of heat having durations of a percentage (e.g., 25%, 50%, or 75%) of the duration of the pulses applied by the heating element 312A, as shown, for example, in pattern 350 of FIG. 3B. As another example, the controller 310A may control the additional heating elements 313A and 314A to apply pulses of heat that commence after a specified time interval following the commencing or ending of a pulse of heat applied by the heating element 312A, as shown in pattern 360 of FIG. 3B.

In response to the determination by the controller 310A of an amount of heat to be applied and the location of the heat application, the heating element 312A may apply the heat to the medium 304A. In some embodiments, the heating element 312A may directly contact the medium 304A during the application of heat. After the heating element 312A applies the heat to the medium 304A, the imperfection 308A may be reduced or eliminated, as shown in 308B.

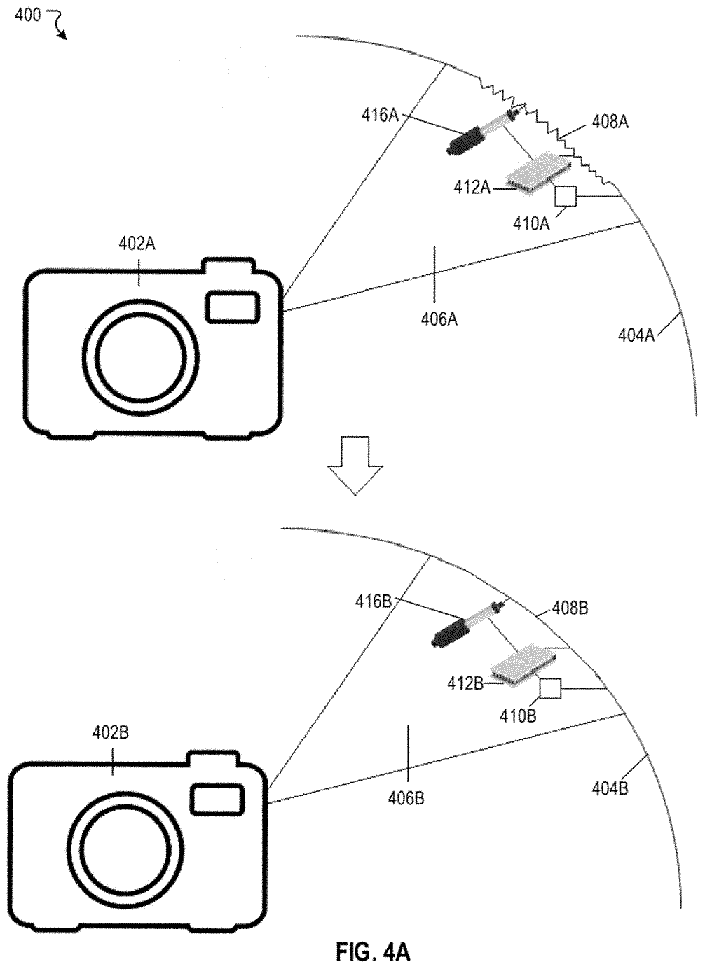

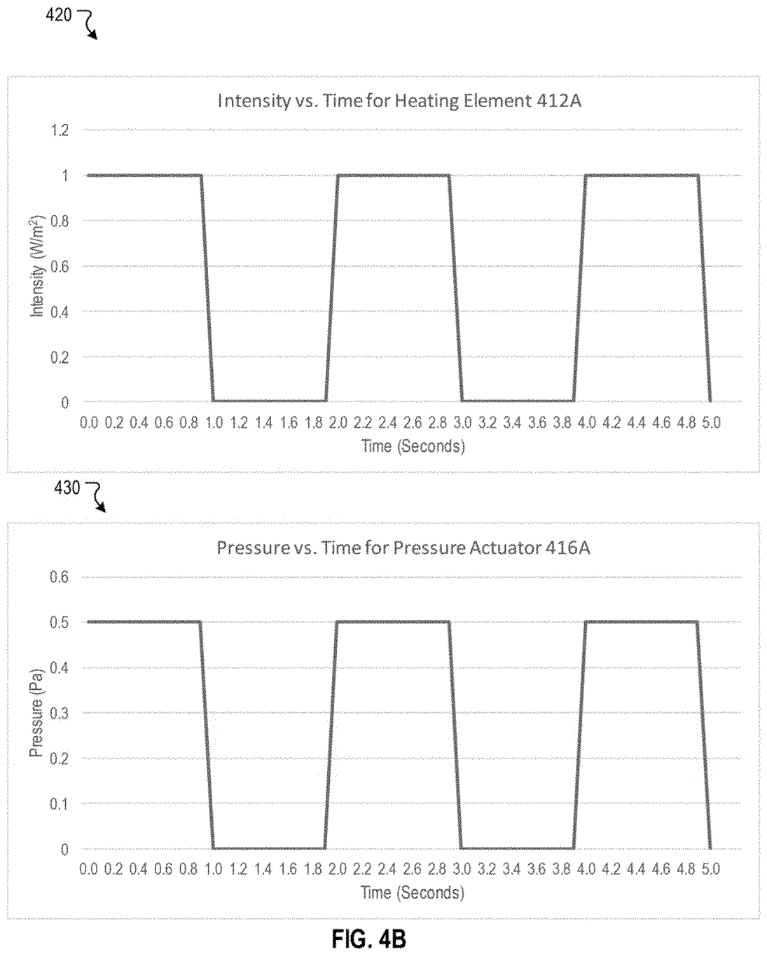

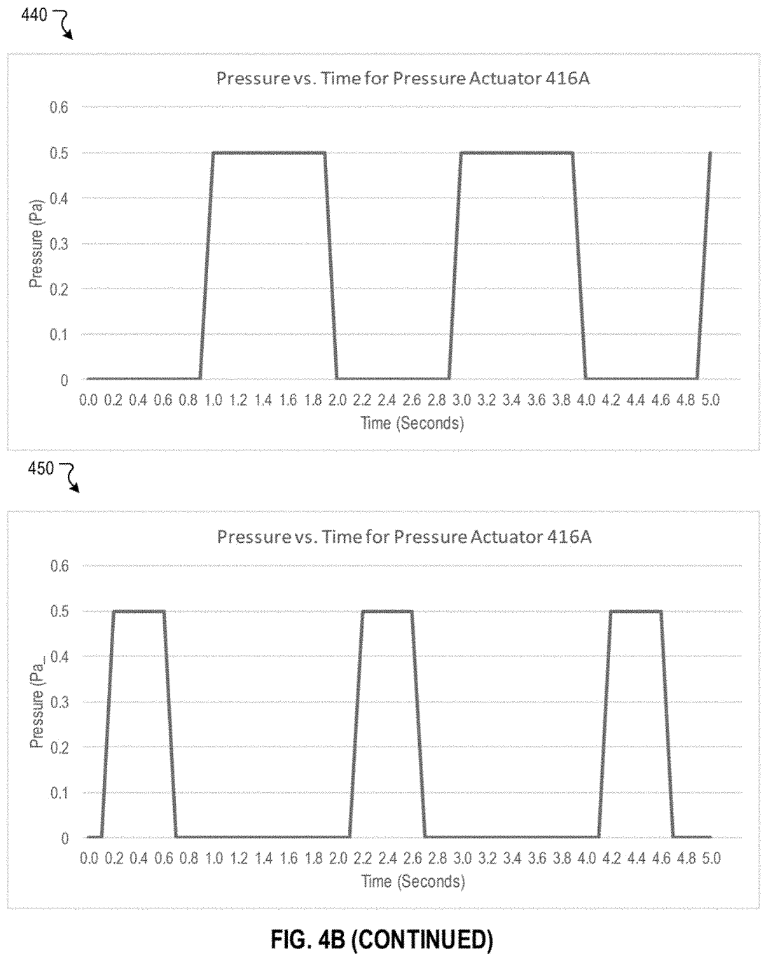

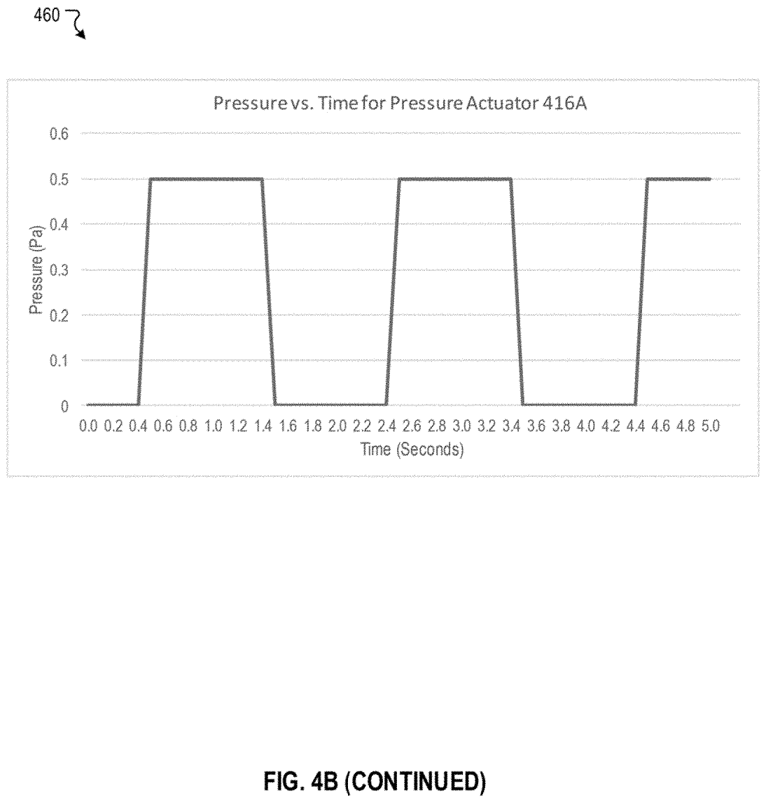

FIG. 4A illustrates an example 400 of a correction mechanism to correct a medium disposed in front of a sensor. In FIG. 4A, a sensor 402A may receive beams through a field of view 406A. The sensor 402A may be a camera, LiDAR, other optical sensor, radar, ultrasonic, infrared sensor, or other sensor. The transmitted beams may pass through a medium 404A comprising an imperfection 408A. The medium 404A may comprise a glass such as a laminated glass or a tempered glass, and/or a plastic. The imperfection 408A may comprise a nonuniform thickness of the medium 404A. A correction system to correct the imperfection 408A may comprise a controller 410A, a heating element 412A, and a pressure actuator 416A. The heating element 412A may comprise a Peltier element, a metal heating element (for example, nickel-based such as nickel-chromium or iron-based), a PTC heating element, and/or a composite heating element. The pressure actuator 416A may be disposed within or outside the field of view 406A. The pressure actuator 416A may reduce the amount of heat applied by the heating element 412A, and reduce a risk of damage due to strain or stress of the medium 404A.

The controller 410A may determine an amount of heat to be applied to the medium 404A, and an amount of pressure to be applied by the pressure actuator 416A, and respective locations at which the heat and the pressure are to be applied. In some embodiments, the controller 410A may determine one of the locations at which the heat is applied to be within the field of view 406A of the sensor 402A. In some embodiments, the controller 410A may move the heating element 412A and/or the pressure actuator 416A to their respective determined locations. In some embodiments, the controller 410A may be configured to determine the amount of heat to be applied by the heating element 412A and/or the amount of pressure to be applied by the pressure actuator 416A as the amount of heat and/or pressure required to produce an image or data satisfying a specific image quality or clarity, or a specific range of image parameters. The controller 410A may pre-determine the amount of heat and/or pressure on a test or pilot sample, as shown in FIG. 2B. In some examples, the controller 410A may compare actual data (e.g., 220) captured by the sensor 402A with reference data 222, which represents a desired image quality. For example, the controller 410A may determine the amount of heat and/or pressure required as that required to obtain an image sufficiently similar to the reference data 222, within a threshold range. As another example, the controller 410A may determine the amount of heat required as that required to obtain one or more parameters within a threshold of the parameters of the reference data 222. For example, the one or more parameters may comprise an optical center, a focal length, a skew, a distortion, an image center, a depth of field, an angle of view, a beam angle, an aspect ratio, and a pixel number, a level of noise, and the like. The one or more parameters of the reference data may be based on a time of day, an amount of ambient light, or an environment condition. In some examples, the controller 410A may dynamically determine the amount of heat during capturing of the sensor data from the sensor 402A, by dynamically assessing a quality of the sensor data or one or more parameters of the sensor data.

The controller 410A may further determine a duration, frequency, or pattern of the heat to be applied to the medium 404A by the heating element 412A. For example, the controller 410A may determine that the pattern of the applied heat to comprise a single pulse or multiple pulses of heat. For example, the controller 410A may determine the pattern of the applied heat by the heating element 412A to comprise one-second pulses of heat at constant amplitude (e.g., amount or intensity) followed by one-second breaks, as shown, for example, in pattern 420 of FIG. 4B. In some examples, the pattern of the applied heat by the heating element 412A may comprise a pulse of heat followed by one or more shorter pulses of heat, or a pulse of heat followed by one or more pulses of lower amplitudes (e.g., amounts or intensities) of heat. The one or more pulses of lower amplitudes, for example, may comprise pulses of constant amplitude or successively decreasing amplitudes, for instance, 1 W/m², 0.9 W/m². 0.81 W/m², wherein each successive pulse is 90% of the intensity of the previous pulse. As an example, once an amount of heat is applied to the medium 404A such that the data or the parameter from the sensor 402A is determined to be within a threshold range of the reference data 222, the controller 402A may regulate the heating element 412A to apply shorter pulses and/or amplitudes (e.g., amounts or intensities) of heat to save energy while preventing the imperfection 408A from reforming.

The controller 410A may further determine the amount of pressure to be applied by the pressure actuator 416A. The controller 410A may further determine a duration, frequency, or pattern of the pressure to be applied to the medium 404A by the pressure actuator 416A. For example, the controller 410A may determine that the duration, frequency, or pattern of the pressure to be applied by the pressure actuator 416A is the same as that applied by the heating element 412A, as shown in pattern 430 of FIG. 4B. In some examples, the controller 410A may synchronize a pattern of the pressure to be applied by the pressure actuator 416A to the pattern of heat applied by the heating element 412A, but may not exactly match the pattern applied by the heating element 412A. For example, the controller 410A may control the pressure actuator 416A to apply pulses of pressure during breaks in which the heating element 412A does not apply pulses of heat, as shown in pattern 440 of FIG. 4B. As another example, the controller 410A may control the pressure pulses of pressure actuator 416A to comprise durations of a percentage (e.g., 25%, 50%, or 75%) of the duration of the pulses applied by the heating element 412A, as shown, for example, in pattern 450 of FIG. 4B. As another example, the controller 410A may control the pressure actuator 416A to apply pulses of pressure that commence after a specified time interval following the commencing or ending of a pulse of heat applied by the heating element 412A, as shown in pattern 460 of FIG. 4B.

In response to the determination by the controller 410A of an amount of heat and/or pressure to be applied and the location of the heat and/or pressure application, the heating element 412A and/or the pressure actuator 416A may apply the heat and/or the pressure to the medium 404A. In some embodiments, the heating element 412A may directly contact the medium 404A during the application of heat, and the pressure actuator 416A may directly contact the medium 404A. After the heating element 412A applies the heat to the medium 404A and the pressure actuator 416A applies the pressure, the imperfection 408A may be reduced or eliminated, as shown in 408B.

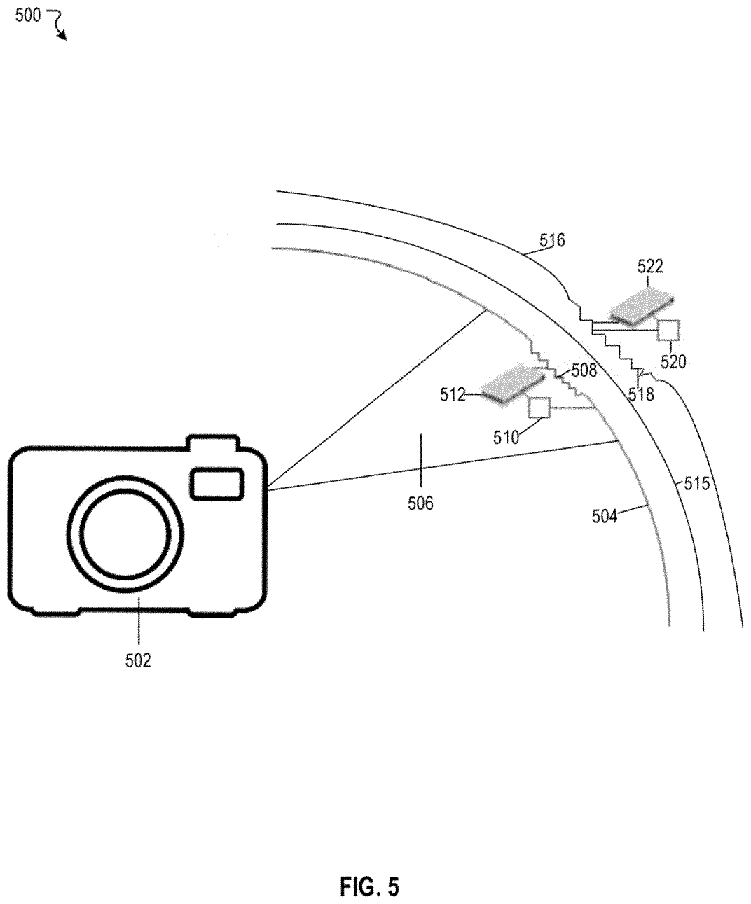

FIGS. 5-7 illustrate configurations 500 of a correction system to correct a medium disposed in front of a sensor. Each of respective mediums of FIGS. 5-7 include a layer of plastic disposed between 2 layers of glass. In FIG. 5, a sensor 502 may receive beams transmitted through a field of view 506. The sensor 202 may be a camera, LiDAR, other optical sensor, radar, ultrasonic, infrared sensor, or other sensor. The transmitted beams may pass through a medium comprising a layer of glass 516, a layer of plastic 515, and a second layer of glass 504, the layer of plastic 515 being disposed between the layers of glass 504 and 516. The second layer of glass 504 may comprise an imperfection 508 and the layer of glass 516 may comprise an imperfection 518. The layers of glass 504 and 516 may comprise a glass such as a laminated glass or a tempered glass. The imperfection 518 may comprise a nonuniform thickness of the layer of glass 516, and/or the layer of glass 516 not being parallel with the second layer of glass 504 and/or the layer of plastic 515. A controller 510 and a heating element 512 may correct the imperfection 508. The heating element 512 may comprise a Peltier element, a metal heating element (for example, nickel-based such as nickel-chromium or iron-based), a PTC heating element, and/or a composite heating element. The controller 510 may be implemented as controller 210A and the heating element 512 may be implemented as heating element 212A. Similarly, a controller 520 and a heating element 522 may correct the imperfection 518. In some embodiments, the controller 510 and the controller 520 may be integrated into a single controller that controls an amount of heat to be applied by both the heating element 512 and the heating element 522. In some embodiments, the controller 520 and the heating element 522 may be implemented as controller 210A and heating element 212A, respectively. In some embodiments, the controller 510 and/or the controller 520 may determine respective locations of the heating elements 512 and 522 to be centered on the field of view 506, and may determine the amount of heat to be applied by both the heating elements 512 and 522 to be equal.

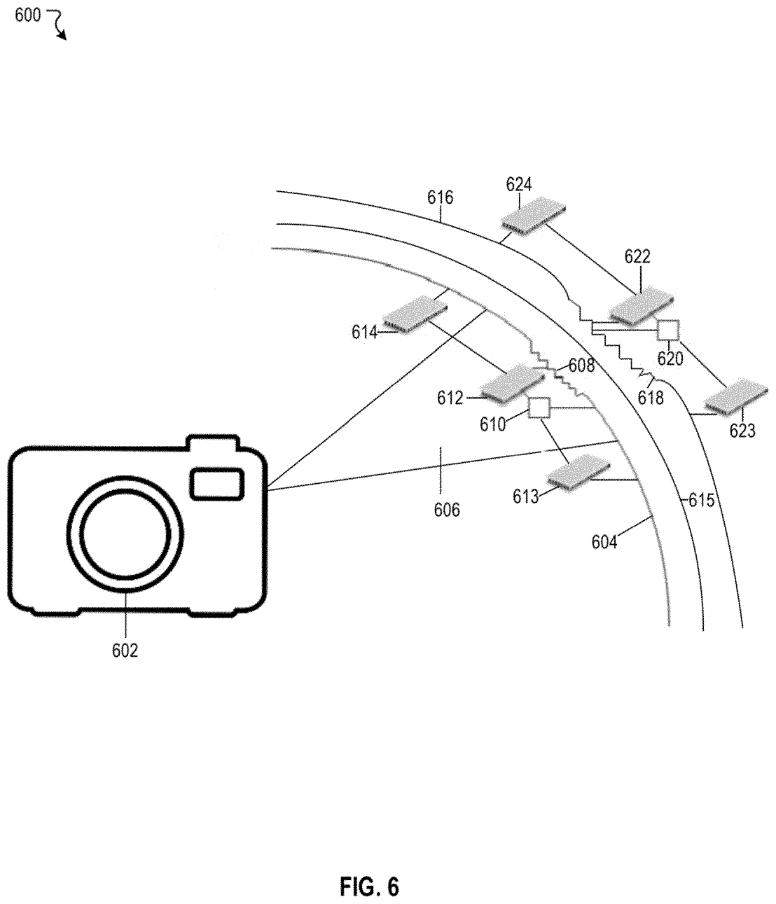

In FIG. 6, a sensor 602 may receive beams transmitted through a field of view 606. The sensor 602 may be a camera, LiDAR, other optical sensor, radar, ultrasonic, infrared sensor, or other sensor. The transmitted beams may pass through a medium comprising a layer of glass 616, a layer of plastic 615, and a second layer of glass 604, the layer of plastic 615 being disposed between the layers of glass 604 and 616. The second layer of glass 604 may comprise an imperfection 608 and the layer of glass 616 may comprise an imperfection 618. The layers of glass 604 and 616 may comprise a glass such as a laminated glass or a tempered glass. A controller 610, a heating element 612, and additional heating elements 613 and 614, may correct the imperfection 608. The heating element 612 may comprise a Peltier element, a metal heating element (for example, nickel-based such as nickel-chromium or iron-based), a PTC heating element, and/or a composite heating element. The controller 610 may be implemented as controller 310A, the heating element 612 may be implemented as heating element 312A, and the additional heating elements 613 and 614 may be implemented as additional heating elements 313A and 314A. Similarly, a controller 620, a heating element 622, and additional heating elements 623 and 624, may correct the imperfection 618. In some embodiments, the controller 610 and the controller 620 may be integrated into a single controller that controls an amount of heat to be applied by the heating element 612, the heating element 622, additional heating elements 613, 614, 623 and 624. In some embodiments, the controller 620, the heating element 622, and the additional heating elements 623 and 624 may be implemented as controller 310A, heating elements 312A, and additional heating elements 313A and 314A, respectively. In some embodiments, the controller 610 and/or the controller 620 may determine respective locations of the heating elements 612 and 622 to be centered on the field of view 606, and may determine the amount of heat to be applied by both the heating elements 612 and 622 to be equal. In some embodiments, the controller 610 and/or the controller 620 may determine respective locations of the two pairs of additional heating elements 613 and 614, and 623 and 624, to be symmetric with respective locations of the heating element 612 and the heating element 622, and may determine the amount of heat to be applied by the additional heating elements 613, 614, 623 and 624, to be equal.

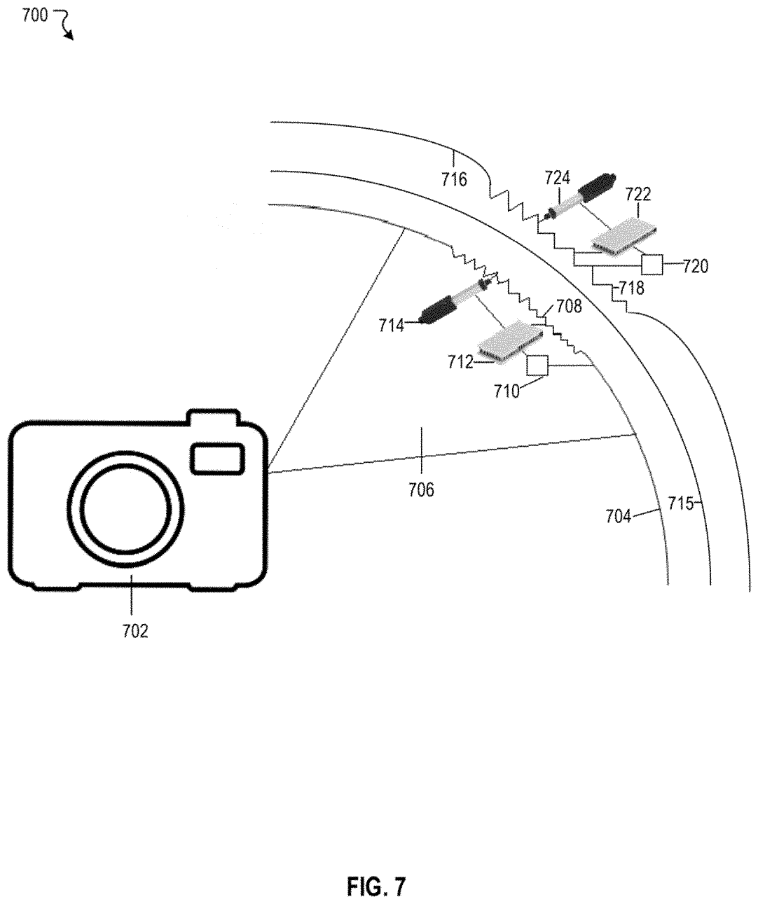

In FIG. 7, a sensor 702 may receive beams transmitted through a field of view 706. The sensor 702 may be a camera, LiDAR, other optical sensor, radar, ultrasonic, infrared sensor, or other sensor. The transmitted beams may pass through a medium comprising a layer of glass 716, a layer of plastic 715, and a second layer of glass 704, the layer of plastic 715 being disposed between the layer of glass 716 and the second layer of glass 704. The second layer of glass 704 may comprise an imperfection 708 and the layer of glass 716 may comprise an imperfection 718. The layers of glass 704 and 716 may comprise a glass such as a laminated glass or a tempered glass. A controller 710, a heating element 712, and a pressure actuator 714, may correct the imperfection 708. The heating element 712 may comprise a Peltier element, a metal heating element (for example, nickel-based such as nickel-chromium or iron-based), a PTC heating element, and/or a composite heating element. The controller 710 may be implemented as controller 410A, the heating element 712 may be implemented as heating element 412A, and the pressure actuator 714 may be implemented as pressure actuator 414A. Similarly, a controller 720, a heating element 722, and a pressure actuator 724, may correct the imperfection 718. In some embodiments, the controller 710 and the controller 720 may be integrated into a single controller that controls an amount of heat to be applied by the heating element 712, the heating element 722, and the pressure actuators 714 and 724. In some embodiments, the controller 720, the heating element 722, and the pressure actuator 724 may be implemented as controller 410A, heating element 412A, and pressure actuator 414A, respectively. In some embodiments, the controller 710 and/or the controller 720 may determine respective locations of the heating elements 712 and 722 to be centered on the field of view 706, and may determine the amount of heat to be applied by both the heating elements 712 and 722 to be equal. In some embodiments, the controller 710 and/or the controller 720 may determine respective locations of the pressure actuators 714 and 724, to be equidistant from the heating elements 712 and 722, respectively. The controller 710 and/or the controller 720 may determine the amount of heat to be applied by the heating elements 712 and 722 to be equal, and the amount of pressure to be applied by the pressure actuators 714 and 724 to be equal.

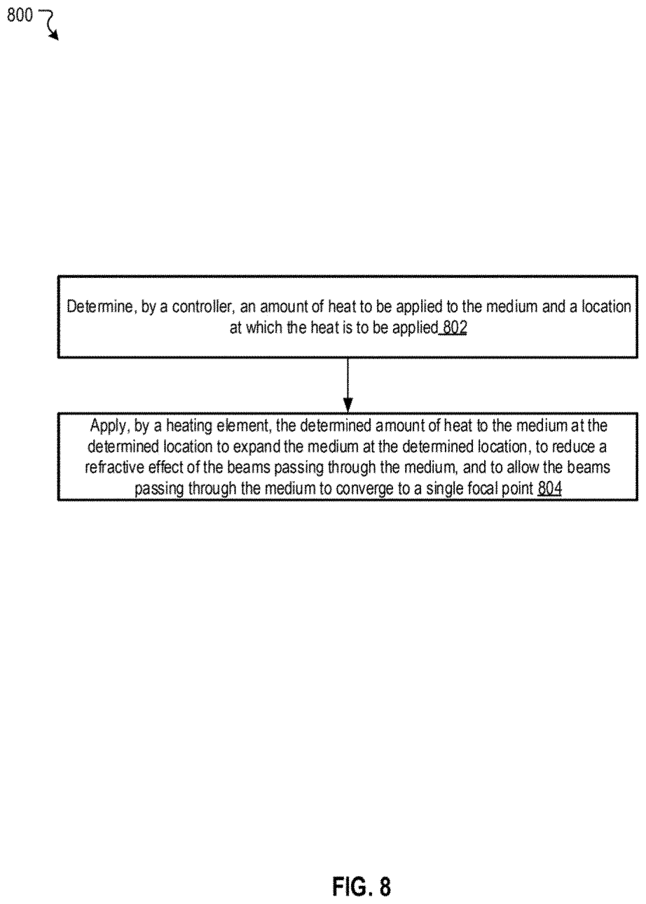

FIG. 8 illustrates a flowchart of a method to correct an imperfection of a medium. In this and other flowcharts, the flowchart 800 illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity. The description from other FIGS. may also be applicable to FIG. 8.

In step 802, a controller may determine an amount of heat to be applied to the medium and a location at which the heat is to be applied. In step 804, a heating element may apply the determined amount of heat to the medium at the determined location. The applying the determined amount of heat reduces a refractive effect of the beams passing through the medium, and allows the beams passing through the medium to converge to a single focal point.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

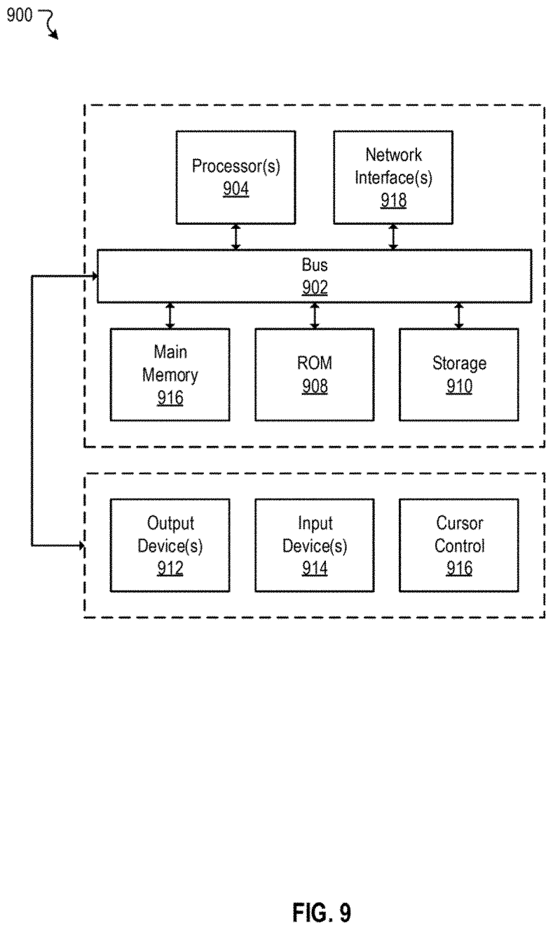

FIG. 9 is a block diagram that illustrates a computer system 900 upon which any of the embodiments described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to output device(s) 912, such as a cathode ray tube (CRT) or LCD display (or touch screen), for displaying information to a computer user. Input device(s) 914, including alphanumeric and other keys, are coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may retrieves and executes the instructions. The instructions received by main memory 906 may optionally be stored on storage device 910 either before or after execution by processor 904.

The computer system 900 also includes a communication interface 918 coupled to bus 902. Communication interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN (or WAN component to communicated with a WAN). Wireless links may also be implemented. In any such implementation, communication interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

For example, “is to be” could mean, “should be,” “needs to be,” “is required to be,” or “is desired to be,” in some embodiments.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Although the invention(s) have been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The foregoing description of the present invention(s) have been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A correction system to correct an imperfection of a medium through which beams pass to a sensor, comprising:
a controller configured to:
determine an amount of heat to be applied to the medium and a location at which the heat is to be applied; and
a heating element configured to:
apply the determined amount of heat to expand the medium at the determined location, to reduce a refractive effect of the beams passing through the medium, and to allow the beams passing through the medium to converge to a single focal point.

2. The correction system of claim 1, wherein the medium is positioned in front of the sensor to which the beams are transmitted;
the controller is configured to:
determine the amount of heat based on a comparison between data captured by the sensor and reference data;
determine the location at which the heat is to be applied to be a location within a field of view of the sensor; and
move the heating element to the determined location.

3. The correction system of claim 2, wherein:
the controller is configured to determine the amount of heat to be such that, in response to the amount of heat being applied to the medium, a difference between a parameter of the data captured by the sensor and a parameter of the reference data is less than a threshold.

4. The correction system of claim 2, wherein:
the controller is configured to determine a duration, frequency, or pattern of the heat to be applied to the medium based on a comparison between data captured by the sensor and reference data; and
in response to the determination, the heating element is configured to apply the determined duration, frequency, or pattern of the heat to the medium.

5. The correction system of claim 1, wherein:
further comprising a second heating element; and
the controller is further configured to determine a second amount of heat to be applied by the second heating element.

6. The correction system of claim 5, wherein the second amount of heat is less than the amount of heat.

7. The correction system of claim 5, wherein the medium comprises a layered composition including a layer of plastic between two outer layers of a glass, and the heating element is disposed on an exterior of and adjacent to one of the outer layers of the glass; and
the second heating element is disposed on an exterior of and adjacent to an other of the one of the outer layers of the glass.

8. The correction system of claim 2, wherein the controller is further configured to determine an amount of pressure to be applied to the medium at the determined location; and further comprising:
a pressure actuator configured to apply the determined amount of pressure.

9. The correction system of claim 8, wherein the controller is configured to determine the amount of pressure and the amount of heat to be such that, in response to the amount of heat and the amount of pressure being applied to the medium, a difference between a parameter of the data captured by the sensor and a parameter of the reference data is less than a threshold.

10. The correction system of claim 8, wherein the controller is further configured to:
limit the amount of pressure or the amount of heat based on a fracture toughness of the medium.

11. The correction system of claim 4, wherein, in response to the controller determining the pattern of the heat, the pattern of the heat comprises a first pulse of heat at a first amplitude for a first duration and a second pulse of heat at a second amplitude for a second duration, wherein the second amplitude is lower than the first amplitude.

12. A correction method to correct an imperfection of a medium, comprising:
determining, by a controller, an amount of heat to be applied to the medium and a location at which the heat is to be applied; and
applying, by a heating element, the determined amount of heat to expand the medium at the determined location, to reduce a refractive effect of the beams passing through the medium, and to allow the beams passing through the medium to converge to a single focal point.

13. The correction method of claim 12, wherein:
the determining the amount of heat is based on a comparison between data captured by a sensor and reference data, the medium being positioned in front of the sensor; and further comprising:
determining, by the controller, a field of view of the sensor;
determining, by the controller, the location at which the heat is to be applied to be a location within the determined field of view; and
moving, by the controller, the heating element to the determined location.

14. The correction method of claim 13, wherein:
the determining the amount of heat comprises determining the amount of heat to be such that, in response to the amount of heat being applied to the medium, a difference between a parameter of the data captured by the optical sensor and a parameter of the reference data is less than a threshold.

15. The correction method of claim 13, further comprising:
determining a duration, frequency, or pattern of the heat to be applied to the medium based on a comparison between data captured by the sensor and reference data; and
in response to the determining the duration, frequency or pattern, applying the determined duration, frequency, or pattern of the heat to the medium.

16. The correction method of claim 12, further comprising:
determining, by the controller, a second amount of heat to be applied by a second heating element.

17. The correction method of claim 16, wherein the determining the second amount of heat comprises determining the second amount of heat to be less than the amount of heat.

18. The correction method of claim 13, further comprising:
determining an amount of pressure to be applied to the medium at the determined location; and
applying the determined amount of pressure at the location.

19. The correction method of claim 18, wherein the determining the amount of pressure and the amount of heat comprises determining the amount of pressure and the amount of heat to be such that, in response to the amount of heat and the amount of pressure being applied to the medium, a difference between a parameter of the data captured by the sensor and a parameter of the reference data is less than a threshold.

20. The correction method of claim 19, wherein the determining the amount of pressure comprises determining the pattern of the heat to comprise a first pulse of heat at a first amplitude for a first duration and a second pulse of heat at a second amplitude for a second duration, wherein the second amplitude is lower than the first amplitude.
